(19) United States
(12) Patent Application Publication
(10) Pub. No.: US 2026/0349810 A1
(43) Pub. Date: Nov. 5, 2026

(54) LLM OUTPUT PERSONALITY ADJUSTMENT

(71) Applicant: International Business Machines Corporation, Armonk, NY (US)

(72) Inventors: Jesus Manuel Olivera, New York, NY (US); Angel Lee, New York, NY (US)

(21) Appl. No.: 19/196,897

(22) Filed: May 2, 2025

(51) Int. Cl. G06F 9/50

(52) U.S. Cl. CPC G06F 9/5027

(57) ABSTRACT

A system includes a processor that executes computer executable components stored in a memory. The computer executable components can include a receiving component that receives a prompt associated with a task. The computer executable components can further include a trait component that identifies an at least one trait associated with a user profile and maps a trait to a corresponding parameter. The computer executable components can further include a generation component that provides the prompt and a parameter to a large language model to generate an output. The computer executable components can further include a customization component that adjusts the parameter to influence future outputs based on an identified trait.

### TECHNICAL FIELD

The subject disclosure relates personality-aware content generation, e.g., improving relevance, tone, or impact of generated content by accounting for traits, preferences, or communication styles.

### BACKGROUND

Advances in large language models (LLMs) have enhanced the ability to generate contextually appropriate content across a variety of domains. In many cases, generated content can be linguistically correct but can lack the nuance and adaptability needed to engage users on a more personal or meaningful level. This limitation can diminish the effectiveness of communication.

Current systems generally treat prompts as isolated inputs, generating responses without regard for context. As a result, outputs can fail to align with audience expectations. This can lead to misunderstandings, reduced engagement, or even negative reactions. There is a recognized need for more adaptive and context-sensitive approaches to content generation.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate personality aware content generation.

According to an embodiment, a system can comprise a processor that executes computer executable components stored in memory. The computer executable components can comprise a receiving component that receives a prompt associated with a task. The computer executable components can further comprise a trait component that identifies an at least one trait associated with a user profile and maps a trait to a corresponding parameter. The computer executable components can further comprise a generation component that provides the prompt and a parameter to a large language model to generate an output. The computer executable components can further comprise a customization component that adjusts the parameter to influence future outputs based on an identified trait.

According to another embodiment, a computer-implemented method can comprise receiving, by a system operatively coupled to a processor, a prompt associated with a task. The computer-implemented method comprises identifying, by a system, an at least one trait associated with a user profile and mapping a trait to a corresponding parameter. The computer-implemented method further comprises providing, by a system, the prompt and a parameter to a large language model to generate an output. The computer implemented method can further comprise adjusting, by the system, the parameter to influence future outputs based on an identified trait.

According to another embodiment, a computer program product comprising a computer readable storage medium having program instructions embodied therewith, the program instructions executable by a processor to cause the processor to receive, by the processor, a prompt associated with a task. The program instructions can also cause the processor to identify, by the processor, an at least one trait associated with a user profile and maps a trait to a corresponding parameter. The program instructions can also cause the processor to provide, by the processor, the prompt and a parameter to a large language model to generate an output. The program instructions can further cause the processor to adjust, by the processor, the parameter to influence future outputs based on an identified trait.

### BRIEF DESCRIPTION OF THE DRAWINGS

FIGS. 1 and 2 illustrate example systems that can facilitate personality aware content generation in accordance with some embodiments described herein.

FIGS. 3 and 4 illustrate flow diagrams, of example computer implemented methods that can facilitate personality aware content generation in accordance with some embodiments described herein.

FIG. 5 illustrates a non-limiting example of a conceptual method for large language model (LLM) personality adjustment, in accordance with embodiments of the present disclosure.

FIG. 6 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

The advancement of large language models (LLMs) has enabled a wide range of applications in content generation. These models can generate contextually relevant and syntactically accurate responses to a broad array of user inputs. Despite impressive linguistic capabilities, current systems often fall short in generating content that meaningfully considers individual traits or preferences of an intended audience. Most existing models are designed to process user prompts in a generalized manner, without considering an emotional tone, cognitive style, or sensitivity level appropriate for a specific user or group.

Conventional content generation systems typically process prompts without regard to interpersonal context in which an output will be used. These systems tend to generate standardized responses that overlook critical nuances, such as a personality, communication style, or emotional expectations of either a person initiating a generation of content or an intended recipient. As a result, generated outputs can be structurally sound or contextually relevant, yet can lack sensitivity or adaptability needed to meet expectations of real-world interactions.

For example, a user drafting an email to a colleague, supervisor, or customer can require different linguistic tones or levels of formality depending on a relationship, context, or audience disposition. A highly analytical initiator can prefer detail rich language, while an intended audience can value brevity and strategic focus. Similarly, a response crafted by a user with a direct communication style can need to be softened when directed toward a more emotionally sensitive recipient. These dynamics emphasize an importance of content generation systems that can take into account both traits of an initiator and characteristics of a target audience to ensure an output is both appropriate and effective.

Current generation frameworks, however, lack a mechanism for incorporating this dual-profile approach. Personalization can often narrowly be focused on an active user and does not dynamically adapt to a specific audience for whom content is intended. Furthermore, there is a lack of integration between psychological traits, such as assertiveness, empathy, or formality, and underlying model parameters that drive tone, structure, or vocabulary choice. This gap limits the ability of existing systems to generate content that is socially aware, emotionally intelligent, or communicatively precise across varied contexts.

Due to the limitations described herein, there remains a need for a more adaptive or context aware approach to content generation. The present disclosure addresses these shortcomings by introducing systems and methods that go beyond traditional prompt-based generation techniques. The approach can incorporate user or audience profiles, trait to parameter mappings, and real time adjustments to tailor outputs to specific communication goals or personality driven preferences.

In view of these limitations, there is a need for a more adaptive approach to content generation that accounts for both an initiator's communication tendencies and an intended audience's personality traits, preferences, or sensitivities. Addressing this need requires a system capable of interpreting user intent alongside interpersonal context, and dynamically adjusting content generation behavior to align with a psychological and stylistic dimension of a given interaction.

According to an embodiment, a system can include a processor that executes computer executable components stored in a memory. The computer executable components can include a receiving component that receives a prompt associated with a task. The computer executable components can further comprise a trait component that identifies an at least one trait associated with a user profile and maps a trait to a corresponding parameter. The computer executable components can further include a generation component that provides the prompt and a parameter to a large language model to generate an output. The computer executable components can further include a customization component that adjusts the parameter to influence future outputs based on an identified trait.

In some embodiments, the computer executable components can further include a feedback component that receives the user feedback related to a generated output. In various embodiments, the feedback can include explicit user ratings, implicit behavioral signals, contextual corrections, or other forms of evaluative input indicating satisfaction or alignment with the generated content.

In various embodiments, the receiving component can receive a natural language prompt describing the task. A prompt can include open-ended questions, declarative instructions, or contextual inputs related to a content generation objective.

In some embodiments, the trait component can select traits from a predefined list mapped to outputs from the large language model. In various embodiments, the trait component can retrieve a baseline parameter associated with the trait, and the customization component can adjust the parameter to reflect a preferred trait intensity. The preferred intensity can be determined based on task requirements, user or audience profiles, contextual cues, or predefined configurations.

In some embodiments, the generation component can generate a task definition from the prompt using the large language model prior to generating the output. The task definition can enable more targeted output generation by disambiguating intent of a prompt, identifying relevant communicative constraints, or guiding downstream trait mapping and parameter selection processes. In various embodiments, the task definition can comprise of at least one of: a task description, a background context, an intended user, or a desired degree of traits.

According to embodiments, the parameter can comprise a value that affects at least one of: tone, formality, verbosity, or sentiment of a generated output. A parameter can be used to control generation behavior in a deterministic or probabilistic manner, depending on the configuration of a large language model. In some embodiments, parameters can include temperature, top-k sampling, top-p sampling, repetition penalty, or other model-level settings that influence linguistic style or content variability.

Embodiments can include the customization component applying the parameter to align the output from the large language model with a target audience profile. In various embodiments, the customization component can modify the parameter in response to the user feedback to intensify or reduce the identified trait. In one or more embodiments, the customization component can dynamically update one or more parameters during response generation to maintain consistency with a desired trait intensity.

A user profile, as used in the present system, can represent a collection of information associated with an individual user or user type. It can include, but is not limited to, communication preferences, personality traits, stylistic tendencies, behavioral patterns, historical interactions, or contextual cues inferred from prior use. A profile can evolve over time based on ongoing interactions, allowing a system to adapt its outputs to align more closely with a user's intent, tone, or interpersonal communication style. Importantly, a user profile is not constrained to static attributes and can incorporate both explicitly provided data and implicitly derived signals to support flexible and context-aware content generation.

Advantages of this system can include personalization of generated content, enhanced alignment with user or audience communication styles, increased effectiveness in delivering context sensitive responses, or more natural interactions.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

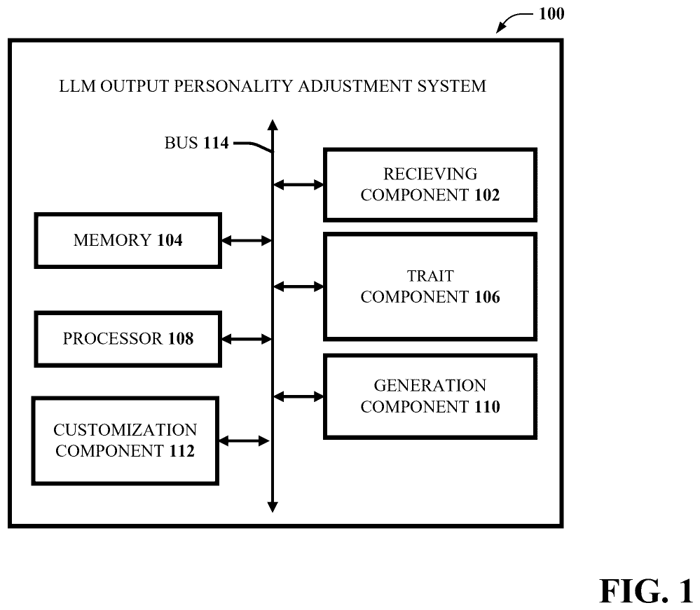

FIG. 1 illustrates an example system 100 for facilitating personality aware content generation in accordance with some embodiments described herein. System 100 uses a receiving component 102, a trait component 106, a generation component 110, and a customization component 112. The receiving component 102 receives a prompt associated with a task. The trait component 106 identifies an at least one trait associated with a user profile and maps a trait to a corresponding parameter. The generation component 110 provides the prompt and a parameter to a large language model to generate an output. The customization component 112 adjusts the parameter to influence future outputs based on an identified trait.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 can comprise a receiving component 102, a memory 104, a trait component 106, a processor 108, a generation component 110, a customization component 112, and a system bus 114.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements such as precise or adaptive language generation through personality-based parameter tuning, context-aware input handling, or output refinement based on user or audience profiles.

System 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the receiving component 102, the trait component 106, generation component 110, and/or the customization component 112) to perform one or more actions. In some embodiments, the memory 104 can store computer-executable components (e.g., the receiving component 102, the trait component 106, generation component 110, and/or the customization component 112).

The system 100 and/or a component thereof as described herein can be communicatively, electrically, operatively, optically, and/or otherwise coupled to one another via a bus 114. The bus 114 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the receiving component 102 can receive a natural language prompt describing the task. A prompt can include open-ended questions, declarative instructions, or contextual inputs related to a content generation objective.

In some embodiments, the trait component 106 can select traits from a predefined list mapped to outputs from the large language model. In various embodiments, the trait component 106 can retrieve a baseline parameter associated with the trait, and the customization component 112 can adjust the parameter to reflect a preferred trait intensity. The preferred intensity can be determined based on task requirements, user or audience profiles, contextual cues, or predefined configurations.

In some embodiments, the generation component 110 can generate a task definition from the prompt using the large language model prior to generating the output. The task definition can enable more targeted output generation by disambiguating intent of a prompt, identifying relevant communicative constraints, or guiding downstream trait mapping and parameter selection processes. In various embodiments, the task definition can comprise of at least one of: a task description, a background context, an intended user, or a desired degree of traits.

According to embodiments, the parameter can comprise a value that affects at least one of: tone, formality, verbosity, or sentiment of a generated output. A parameter can be used to control generation behavior in a deterministic or probabilistic manner, depending on the configuration of a large language model. In some embodiments, parameters can include temperature, top-k sampling, top-p sampling, repetition penalty, or other model-level settings that influence linguistic style or content variability.

Embodiments can include the customization component 112 applying the parameter to align the output from the large language model with a target audience profile. In various embodiments, the customization component 112 can modify the parameter in response to the feedback to intensify or reduce the identified trait. In one or more embodiments, the customization component 112 can dynamically update one or more parameters during response generation to maintain consistency with a desired trait intensity.

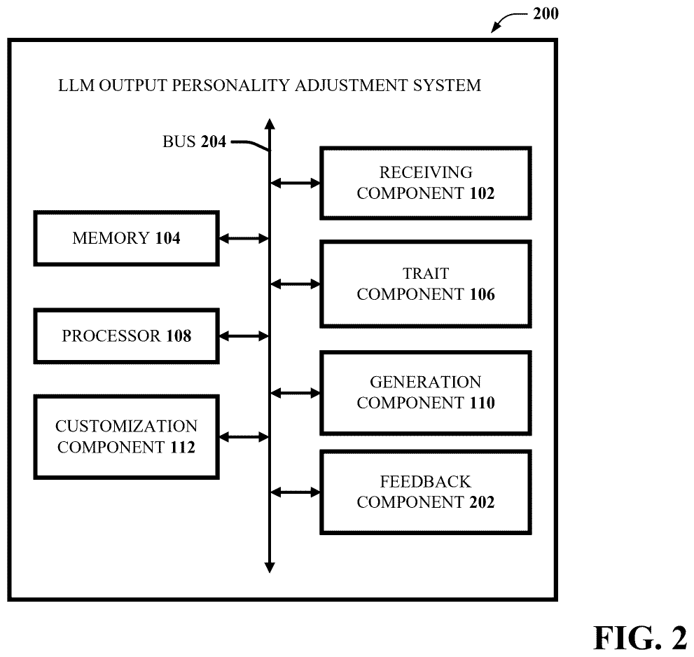

FIG. 2 illustrates an example system 200 that can facilitate personality aware content generation. System 200 uses a receiving component 102, a trait component 106, a generation component 110, a customization component 112, and a feedback component 202. The receiving component 102 receives a prompt associated with a task. The trait component 106 identifies an at least one trait associated with a user profile and maps a trait to a corresponding parameter. The generation component 110 provides the prompt and a parameter to a large language model to generate an output. The customization component 112 adjusts the parameter to influence future outputs based on an identified trait. The feedback component 202 receives the user feedback related to a generated output. Description of like components has been omitted for the sake of brevity.

The feedback component can receive input from a user or an external system. In various embodiments, the feedback can include explicit user ratings, implicit behavioral signals, contextual corrections, or other forms of evaluative input indicating satisfaction or alignment with the generated content. This feedback can be used to inform parameter adjustments, either in real time or asynchronously, allowing a system to refine future outputs for better alignment with user expectations, personality traits, or audience preferences. A feedback loop can enable continuous learning or adaptation within a content generation workflow.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

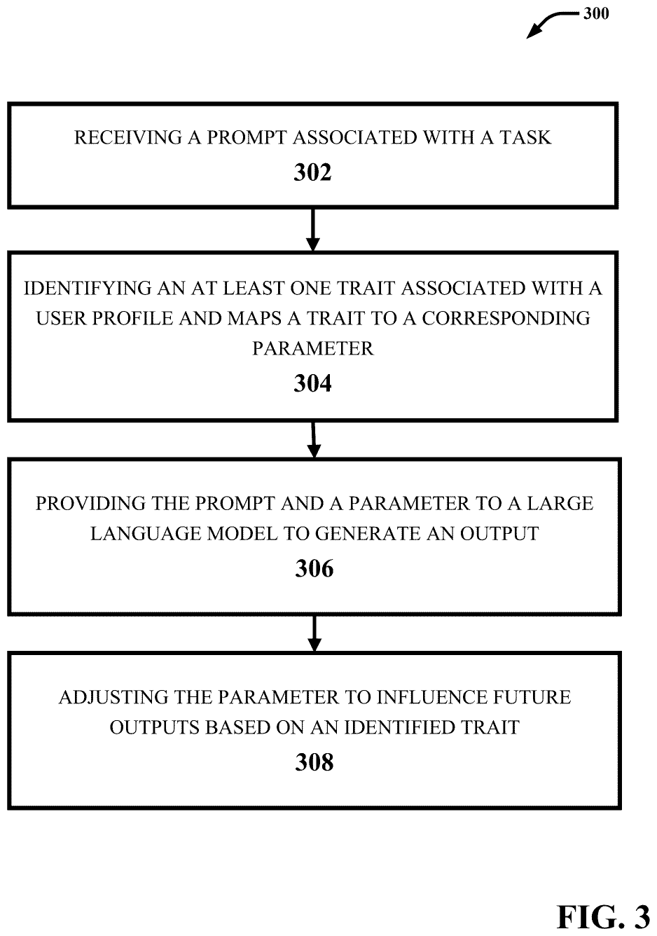

Next, FIG. 3 illustrates a flow diagram of a method 300 that can facilitate personality aware content generation in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 includes receiving a prompt associated with a task. The method 300 can use a system operatively coupled to the processor (e.g., receiving component 102) to receive a prompt associated with a task. In some embodiments, a prompt can be in the form of natural language, structured input, or multimodal data, and can relate to a wide range of communication goals, such as composing a message, generating a summary, or responding to a query.

At 304, method 300 includes identifying an at least one trait associated with a user profile and maps a trait to a corresponding parameter. The method 300 can use a system operatively coupled to the processor (e.g., trait component 106) to identify an at least one trait associated with a user profile and maps a trait to a corresponding parameter. In various embodiments, a trait can be inferred from historical interactions, contextual inputs, or predefined profile data, and mapping can be based on configurable or learned associations that guide large language model (LLM) behavior.

At 306, method 300 includes providing the prompt and a parameter to a large language model to generate an output. The method 300 can use a system operatively coupled to the processor (e.g., generation component 110) to provide the prompt and a parameter to a large language model to generate an output. A prompt and a parameter can be combined or separately provided as input, or in some cases, additional contextual metadata can be included to further tailor a model's response.

At 308, method 300 includes adjusting the parameter to influence future outputs based on an identified trait. The method 300 can use a system operatively coupled to the processor (e.g., customization component 112) to adjust the parameter to influence future outputs based on an identified trait. In various embodiments, adjustment can be static, dynamic, rule-based, or learned over time, and can operate at runtime or as part of a pre-processing phase, depending on system configuration.

In some embodiments, method 300 is performed by a system, such as system 100 of FIG. 1 or system 200 of FIG. 2. The receiving a prompt associated with a task 302 can be performed by a receiving component (e.g., receiving component 102 of FIG. 1). The identifying an at least one trait associated with a user profile and maps a trait to a corresponding parameter 304 can be performed by a trait component (e.g., trait component 106). Providing the prompt and a parameter to a large language model to generate an output 306 can be performed by a generation component (e.g., generation component 110). The adjusting the parameter to influence future outputs based on an identified trait 308 can be performed by a customization component (e.g., customization component 112).

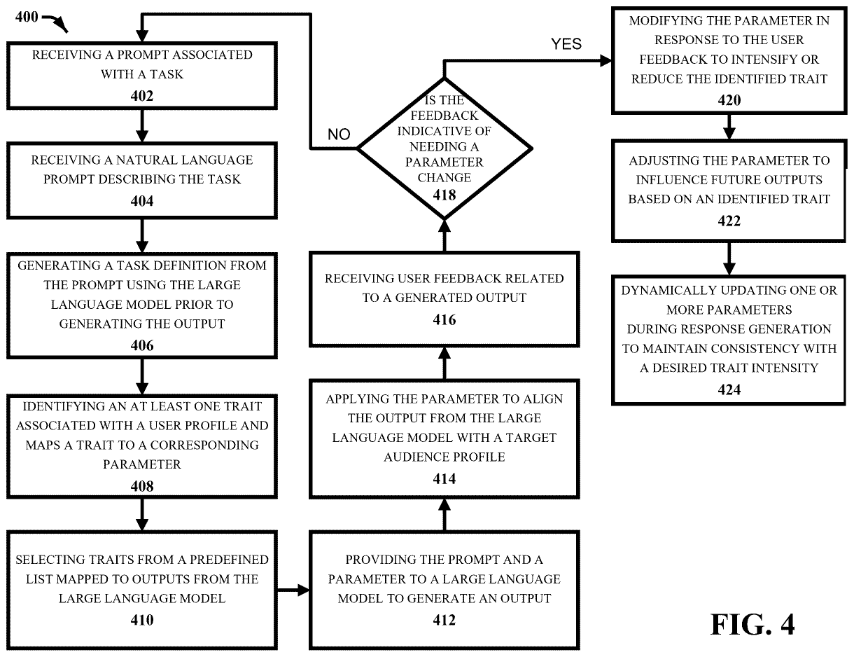

Next, FIG. 4 illustrates a flow diagram of a method 400 that can facilitate personality aware content generation in accordance with some embodiments described herein. While the method 400 is described relative to the system 100 of FIG. 1, the method 400 can be applicable also to other systems described herein.

At 402, the method 400 includes receiving a prompt associated with a task. The method 400 can use a system operatively coupled to the processor (e.g., receiving component 102) to receive a prompt associated with a task. In some embodiments, a prompt can be in the form of natural language, structured input, or multimodal data, and can relate to a wide range of communication goals, such as composing a message, generating a summary, or responding to a query.

At 404, method 400 includes receiving a natural language prompt describing the task. The method 400 can use a system operatively coupled to the processor (e.g., receiving component 102) to receive a natural language prompt describing the task.

At 406, method 400 includes generating a task definition from the prompt using the large language model prior to generating the output. The method 400 can use a system operatively coupled to the processor (e.g., generation component 110) to generate a task definition from the prompt using the large language model prior to generating the output. In some embodiments, a task definition can be generated using one or more auxiliary models or rule-based components. In various embodiments, a task definition can include intent classification, goal identification, or contextual tagging.

At 408, method 400 includes identifying an at least one trait associated with a user profile and maps a trait to a corresponding parameter. The method 400 can use a system operatively coupled to the processor (e.g., trait component 106) to identify an at least one trait associated with a user profile and maps a trait to a corresponding parameter. In some cases, a trait can be inferred dynamically from current inputs or contextual signals, rather than retrieved from a static profile.

At 410, method 400 includes selecting traits from a predefined list mapped to outputs from the large language model. The method 400 can use a system operatively coupled to the processor (e.g., trait component 106) to select traits from a predefined list mapped to outputs from the large language model. A predefined list can be configurable, extensible, or generated through machine learning processes to evolve with system use.

At 412, method 400 includes providing the prompt and a parameter to a large language model to generate an output. The method 400 can use a system operatively coupled to the processor (e.g., generation component 110) to provide the prompt and a parameter to a large language model to generate an output. In some embodiments, a parameter can be encoded directly into the prompt or supplied through an external control mechanism.

At 414, method 400 includes applying the parameter to align the output from the large language model with a target audience profile. The method 400 can use a system operatively coupled to the processor (e.g., customization component 112) to apply the parameter to align the output from the large language model with a target audience profile. An application of a parameter can occur before, during, or after response generation.

At 416, method 400 includes receiving user feedback related to a generated output. The method 400 can use a system operatively coupled to the processor (e.g., feedback component 202) to receive user feedback related to a generated output. Feedback can be captured explicitly or passively, and can originate from an initiating user, a third-party reviewer, or automated evaluation systems.

At 418, method 400 includes determining whether the received feedback is indicative of a need to change a parameter. The method 400 can use a system operatively coupled to the processor (e.g., feedback component 202, customization component 112) to determine whether the received feedback is indicative of a need to change a parameter. If the feedback indicates a need for change, the method proceeds to 420. If not, such as when the feedback is neutral, contradictory, or falls below a threshold of significance, a method returns to 402 to continue processing using an existing or a new prompt. Evaluation can involve heuristic logic, rule-based thresholds, or learned models trained on historical feedback-response patterns.

At 420, method 400 includes modifying the parameter in response to the user feedback to either intensify or reduce the identified trait. The method 400 can use a system operatively coupled to the processor (e.g., customization component 112) to adjust one or more generation parameters associated with the trait, thereby influencing the tone, style, or content characteristics of future outputs generated by the language model. After completing 420, the method proceeds to 422. Parameter adjustment can be incremental, binary, or probabilistic, based on system configuration.

At 422, method 400 includes adjusting the parameter to influence future outputs based on the identified trait. The method 400 can use a system operatively coupled to the processor to (e.g., customization component 112) apply the updated or retained parameter value in subsequent content generation processes, allowing the system to maintain alignment with user or audience expectations over time, even across iterative prompt evaluations. In some cases, adjustment can be stored in a user profile, session record, or model cache to ensure continuity across interactions.

At 424, method 400 includes dynamically updating one or more parameters during response generation to maintain consistency with a desired trait intensity. The method 400 can use a system operatively coupled to the processor (e.g., customization component 112) to monitor the ongoing generation process and adjust applicable parameters in real time, ensuring that the output remains aligned with the target personality trait or communication style. This process can be applied at various stages of generation and can involve token level or phrase level adjustments using streaming generation techniques or attention-based control.

One or more systems, devices, computer program products, and/or computer-implemented methods provided herein relate to generating contextually adaptive content using large language models, wherein output is modulated based on personality traits, user profiles, or audience characteristics. Systems described herein can enhance the relevance, tone, and overall communicative effectiveness of generated content. A system can include a processor that executes computer executable components stored in memory. The computer executable components can include a receiving component that receives a prompt associated with a task. The computer executable components can further include a trait component that identifies an at least one trait associated with a user profile and maps a trait to a corresponding parameter. The computer executable components can further include a generation component that provides the prompt and a parameter to a large language model to generate an output. The computer executable components can further include a customization component that adjusts the parameter to influence future outputs based on an identified trait. The computer executable components can further include a feedback component that receives the user feedback related to a generated output.

Advantages of this system can include personalization of generated content, enhanced alignment with user or audience communication styles, increased effectiveness in delivering context sensitive responses, or more natural interactions.

In various embodiments, the feedback can include explicit user ratings, implicit behavioral signals, contextual corrections, or other forms of evaluative input indicating satisfaction or alignment with the generated content.

In some embodiments, the receiving component can receive a natural language prompt describing the task. A prompt can include open-ended questions, declarative instructions, or contextual inputs related to a content generation objective.

In various embodiments, the trait component can select traits from a predefined list mapped to outputs from the large language model. In some embodiments, the trait component can retrieve a baseline parameter associated with the trait, and the customization component can adjust the parameter to reflect a preferred trait intensity. The preferred intensity can be determined based on task requirements, user or audience profiles, contextual cues, or predefined configurations.

In some embodiments, the generation component can generate a task definition from the prompt using the large language model prior to generating the output. The task definition can enable more targeted output generation by disambiguating intent of a prompt, identifying relevant communicative constraints, or guiding downstream trait mapping and parameter selection processes. In various embodiments, the task definition can comprise of at least one of: a task description, a background context, an intended user, or a desired degree of traits.

According to embodiments, the parameter can comprise a value that affects at least one of: tone, formality, verbosity, or sentiment of a generated output. A parameter can be used to control generation behavior in a deterministic or probabilistic manner, depending on the configuration of a large language model. In some embodiments, parameters can include temperature, top-k sampling, top-p sampling, repetition penalty, or other model-level settings that influence linguistic style or content variability.

Embodiments can include the customization component applying the parameter to align the output from the large language model with a target audience profile. In various embodiments, the customization component can modify the parameter in response to the user feedback to intensify or reduce the identified trait. In one or more embodiments, the customization component can dynamically update one or more parameters during response generation to maintain consistency with a desired trait intensity.

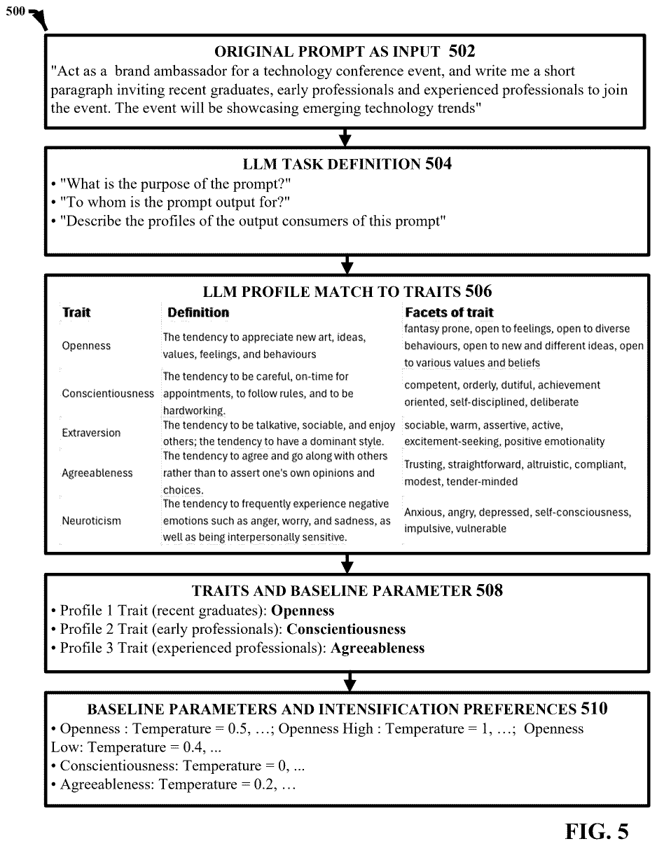

FIG. 5 illustrates a non-limiting example of a conceptual method for large language model (LLM) personality adjustment, in accordance with embodiments of the present disclosure.

At step 502, a user can input an original prompt requesting content for a specific communication task. In the example, an inputted prompt involves drafting an invitation to a technology conference, targeting multiple audience segments including recent graduates and professionals at varying career stages. This input can serve as the basis for identifying relevant traits and determining how generated content should be styled to suit an intended audience.

At step 504, a system can perform task definition using a large language model (LLM). This can involve analyzing a prompt to extract key elements such as a purpose of a request, an intended audience, and an expected consumer profile of an output. In this example, a system can identify that a goal is to generate an engaging invitation, directed toward individuals at different stages of their professional journey, including recent graduates and experienced professionals. This understanding can guide downstream decisions about tone, style, or trait alignment in a content generation process.

At step 506, the system performs a profile-to-trait matching operation using a large language model (LLM). Based on a task definition and an identified audience profile, a system can map characteristics of an intended recipient to relevant psychological or personality traits. For example, if the audience includes individuals who are receptive to innovation and emerging trends, a system can associate this group with the trait of openness. Each trait is defined with associated behavioural facets, such as imagination, emotional receptivity, or openness to new experiences, and help refine generated content. This trait mapping can enable a system to guide generation parameters in a way that aligns with audience expectations and preferences.

At step 508, a system can establish baseline parameter settings for content generation based on traits identified in the previous step 506. Each target audience profile can be associated with a specific personality trait that reflects their likely communication preferences. For instance, recent graduates can be mapped to openness, suggesting a preference for imaginative or forward-looking language. Early professionals can align with conscientiousness, favouring structured or goal-oriented messaging. Experienced professionals can be associated with agreeableness, indicating a preference for respectful, cooperative, or inclusive language. These trait-to-parameter associations can serve as a foundation for configuring a large language model to generate appropriately tailored output for each audience segment.

At step 510, a system can apply baseline parameters or intensification preferences associated with an identified trait. Each personality trait can be linked to specific language model settings, such as temperature, top-p sampling, or repetition penalties. Language model setting can be modified to influence tone or style of a generated output. For example, openness can use a moderate temperature value by default (e.g., 0.5), with higher or lower values applied to intensify or reduce creativity or expressiveness as needed. Conscientiousness can be paired with a lower temperature (e.g., 0), reflecting a preference for precise or structured output, while agreeableness can use a slightly elevated setting (e.g., 0.2) to encourage warmth or cooperative tone. These parameter configurations can enable control over how each trait is reflected in a large language model's response, ensuring content aligns with a communication preference of each audience profile.

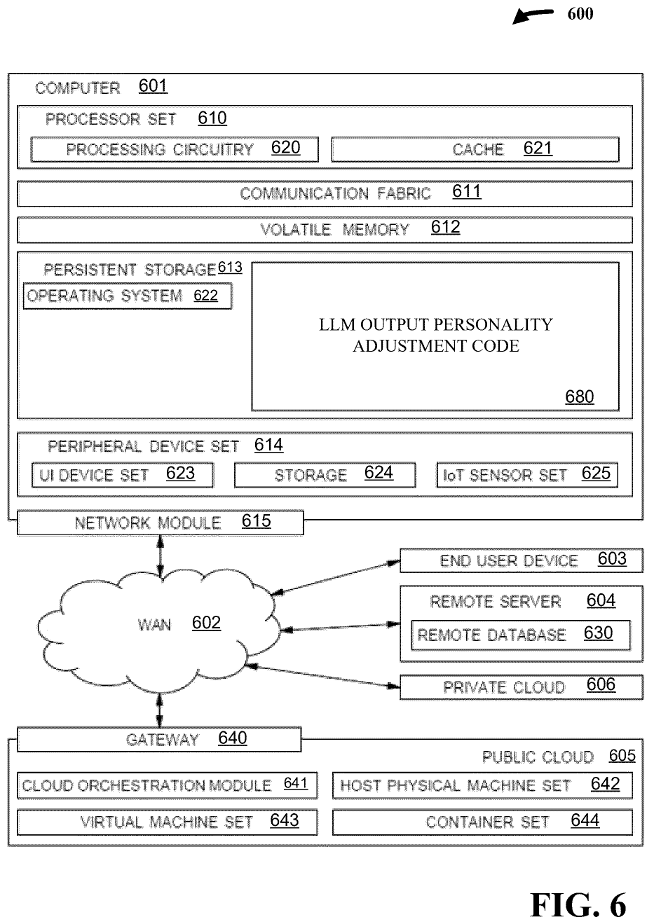

FIG. 6 and the following discussion are intended to provide a brief, general description of a suitable computing environment 600 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as large language model (LLM) output personality adjustment code 680. In addition to block 680, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 680, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method can be distributed among multiple computers and/or between multiple locations. On the other hand, in this presentation of computing environment 600, detailed discussion is focused on a single computer, specifically computer 601, to keep the presentation as simple as possible. Computer 601 can be located in a cloud, even though it is not shown in a cloud in FIG. 6. On the other hand, computer 601 is not required to be in a cloud except to any extent as can be affirmatively indicated.

PROCESSOR SET 610 includes one, or more, computer processors of any type now known or to be developed in the future. Processing circuitry 620 can be distributed over multiple packages, for example, multiple, coordinated integrated circuit chips. Processing circuitry 620 can implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set can be located “off chip.” In some computing environments, processor set 610 can be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods can be stored in block 680 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory can be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 can be a read only memory (ROM), but typically at least a portion of the persistent storage allows writing of data, deletion of data and re-writing of data. Some familiar forms of persistent storage include magnetic disks and solid-state storage devices. Operating system 622 can take several forms, such as various known proprietary operating systems or open-source Portable Operating System Interface type operating systems that employ a kernel. The code included in block 680 typically includes at least some of the computer code involved in performing the inventive methods.

PERIPHERAL DEVICE SET 614 includes the set of peripheral devices of computer 601. Data communication connections between the peripheral devices and the other components of computer 601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 can include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 can be persistent and/or volatile. In some embodiments, storage 624 can take the form of a quantum computing storage device for storing data in the form of qubits. In embodiments where computer 601 is required to have a large amount of storage (for example, where computer 601 locally stores and manages a large database) then this storage can be provided by peripheral storage devices designed for storing large amounts of data, such as a storage area network (SAN) that is shared by multiple, geographically distributed computers. IoT sensor set 625 is made up of sensors that can be used in Internet of Things applications. For example, one sensor can be a thermometer, and another sensor can be a motion detector.

NETWORK MODULE 615 is the collection of computer software, hardware, and firmware that allows computer 601 to communicate with other computers through WAN 602. Network module 615 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and can take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 can be a client device, such as thin client, heavy client, mainframe computer and/or desktop computer.

REMOTE SERVER 604 is any computer system that serves at least some data and/or functionality to computer 601. Remote server 604 can be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data can be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs can be stored as images and can be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware and firmware allowing public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a receiving component that receives a prompt associated with a task;
a trait component that identifies an at least one trait associated with a user profile and maps a trait to a corresponding parameter;
a generation component that provides the prompt and a parameter to a large language model to generate an output; and
a customization component that adjusts the parameter to influence future outputs based on an identified trait.

2. The system of claim 1, wherein the receiving component receives a natural language prompt describing the task.

3. The system of claim 1, wherein the generation component generates a task definition from the prompt using the large language model prior to generating the output.

4. The system of claim 3, wherein the task definition comprises at least one of: a task description, a background context, an intended user, or a desired degree of traits.

5. The system of claim 1, wherein the trait component selects traits from a predefined list mapped to outputs from the large language model.

6. The system of claim 1, wherein the parameter comprises a value that affects at least one of: tone, formality, verbosity, or sentiment of a generated output.

7. The system of claim 1, wherein the customization component applies the parameter to align the output from the large language model with a target audience profile.

8. The system of claim 1, further comprising a feedback component that receives the user feedback related to a generated output.

9. The system of claim 8, wherein the customization component modifies the parameter in response to the feedback to intensify or reduce the identified trait.

10. The system of claim 1, wherein the customization component dynamically updates one or more parameters during response generation to maintain consistency with a desired trait intensity.

11. The system of claim 1, wherein the trait component retrieves a baseline parameter associated with the trait, and the customization component adjusts the parameter to reflect a preferred trait intensity.

12. A computer-implemented method that utilizes a processor that executes computer executable components stored in memory to perform the following acts:
receiving a prompt associated with a task;
identifying an at least one trait associated with a user profile and mapping a trait to a corresponding parameter;
providing the prompt and a parameter to a large language model to generate an output; and
adjusting the parameter to influence future outputs based on an identified trait.

13. The method of claim 12, further comprising receiving a natural language prompt describing the task.

14. The method of claim 12, further comprising generating a task definition from the prompt using the large language model prior to generating the output.

15. The method of claim 12, further comprising selecting traits from a predefined list mapped to outputs from the large language model.

16. The method of claim 12, further comprising applying the parameter to align the output from the large language model with a target audience profile.

17. The method of claim 12, further comprising receiving user feedback related to a generated output.

18. The method of claim 17, further comprising modifying the parameter in response to the user feedback to intensify or reduce the identified trait.

19. The method of claim 12, further comprising dynamically updating one or more parameters during response generation to maintain consistency with a desired trait intensity.

20. A computer program product comprising a computer readable storage medium having program instructions embodied therewith, the program instructions executable by a processor to cause the processor to:
receive a prompt associated with a task;
identify an at least one trait associated with a user profile and maps a trait to a corresponding parameter;
provide the prompt and a parameter to a large language model to generate an output; and
adjust the parameter to influence future outputs based on an identified trait.
